(19) United States
(12) Patent Application Publication
(10) Pub. No.: US 2009/0178224 A1
(43) Pub. Date: Jul. 16, 2009

(54) UNIVERSAL SPATTLE FOR LIQUID MATERIALS WIPING AND SMEARING

(76) Inventor: Petr Fronek, Praha (CZ)

Correspondence Address: COATS & BENNETT, PLLC, 1400 Crescent Green, Suite 300, Cary, NC, 27518, US

(21) Appl. No.: 12/297,787

(22) PCT Filed: Apr. 20, 2007
(86) PCT No.: PCT/CZ2007/000030

§ 371 Date: Nov. 10, 2008

(30) Foreign Application Priority Data
Apr. 20, 2006 (CZ) PUV 2006-17651

(51) Int. Cl. B05C 17/10

(52) U.S. Cl. 15/235.8

(57) ABSTRACT

Spattle for wiping and smearing liquid materials, namely binders over surfaces, namely curved, is composed of a flexible base plate (1) which is connected to the spattle's handle (14) through mutually connected levers (5, 9), that evenly transfer the pressure conducted on the spattle's handle (14) over the whole length of the base plate (1), where the amount of levers is not fixed.

### TECHNICAL FIELD

This solution relates to universal spattle for wiping and smearing liquid materials, namely binders over surfaces, namely curved.

### BACKGROUND ART

For wiping and smearing binders or other liquid materials over curved surfaces, various spattles are currently used, mostly straight, with various hardness and length, according to the measurements and the curve diameter of the surface, or hard spattles formed by a template, copying the curves of the surface. When a straight spattle is used and especially when the curve diameter is big or the surface is large, it is very difficult to find the optimal shape or hold the optimal level and lay the binder on only in needed amount and on the desired areas. Especially when wide spattles are used, it happens that there is different pressure on the edge of the spattle under the handle than on the other parts of the edge, which causes uneven deformation of the spattle's edge, and the shape of the edge is thus not ideal either for even or curved surface. This problem arises namely with the wide spattles and smoothing beams. When hard and template-formed spattle is used, it is needed to create an extra spattle for each curve.

### DISCLOSURE OF THE TECHNICAL SOLUTION

Said disadvantages are removed by spattle for wiping and smearing liquid materials, namely binders over surfaces, namely curved, according to the present technical solution, the principle of which is that the pressure, being created on the spattle's handle or handles during the use, is transferred to the base plate over a lever, and by this lever, it is transferred over consoles to more points. The amount of these points is defined by the amount of levers and consoles, over which the pressure is being transferred.

The base plate or the edge of the spattle's base plate is thus being pressed to the surface being covered with the binder with approximately same force all over the length.

The consoles are permanently fixed to the base plate and they are movably connected with the lever by plurality of plugs. The plug is penetrating one end of the lever through a hole, and on the other end of the lever, the plug is moving in a channel. This keeps the base plate flexible and it allows the base plate being curved according to the surface being covered with the binder. The console containing the plug moving in the channel can be fixed to the channel, which causes the fixation of the preset curve of the base plate.

When two or more levers are used, these levers are connected by plurality of other levers, where the bottom levers function as consoles as well. The function and the technical solution are similar as written above. The top lever serves as the spattle's handle.

The present technical solution allows the usage of long spattles, when the pressure on the spattle's handle is equally transferred over its whole length and enables the optimal forming of the spattle, according to the covered surface.

The consoles, which are permanently fixed to the base plate, also serve as stirrups into which an additional stiffener of the base plate can be inserted, thus setting the optimal hardness of the base plate, increasing the usability of the device according to the present technical solution.

### DISCLOSURE OF THE FIGURES

The technical solution is going to be explained by using the drawings, on which the

FIG. 1 pictures the device according to the present technical solution, where the pressure on the base plate, namely on the edge of the base plate, is transferred from the spattle's handle over six levers. In this case, the handle constitutes the seventh, independent lever.

FIG. 2 pictures close-up of a console with a plug, creating also a stirrup for fixing the additional stiffener of the base plate, and close-up of the connection of a console and a lever by a plug.

FIG. 3 pictures close-up of the lever channel and the plugged console, with the possibility of mutual position fixing by a screw.

FIG. 4 pictures the embodiment in which the base plate is being provided with a T-profile with one wiping edge being perpendicular to the covered surface.

### EXAMPLES OF THE EMBODIMENT OF THE TECHNICAL SOLUTION

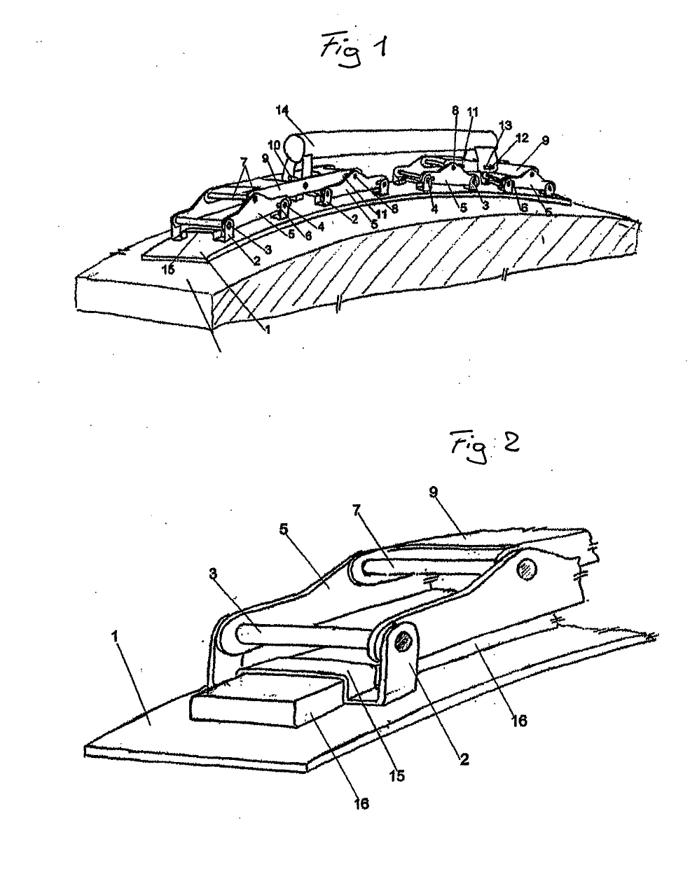

The spattle, according to FIG. 1, comprises the base plate 1, on which the consoles 2 with plugs 3 and 4 are placed. Each two consoles are connected by levers 5, having on one end a hole for the plug 3 and on the other end the channel 6 in which the plug 4 moves. The movement is caused by any curving of the base plate 1, when the distance between plugs 3 and 4 changes. The levers 5 contain plugs 7 and 8. Levers 5 are mutually connected by levers 9, in the middle of which the plug 10 is located. On one end of this lever, there is a hole for the plug 7 and on the other end there is the channel 11, in which the plug 8 of the lever 5 moves. The function of this channel of lever 9 is similar to that of lever 5. When the base plate 1 is curved, the distance between plugs 7 and 8 changes again, allowed by the channel 11. The levers 9 are connected by another lever 14, of similar construction to the other levers with a hole for the plug 10 and channel 13 for the plug 12. Moreover, the lever 14 in this case serves also as the spattle's handle.

The function of the levers 14, 9 and 5 is that the pressure on the spattle's handle is being transferred equally over the whole length of the base plate and the levers ensure approximately constant thrust to the covered surface along the whole length of the spattle.

The channels on each lever additionally allow the base plate curving according to the covered surface, while maintaining the primal function of the levers.

The consoles 2 according to FIG. 2 are designed in such way that they as well constitute stirrups 15 for fixing the changeable additional stiffener 16 (see FIG. 2). The additional stiffener 16 is inserted into stirrups and fixed to one of them. This construction allows choosing between different flexibility of the base plate 1. The additional stiffener is not present in FIG. 1.

The base plate 1 can be provided with Velcro in the bottom, and this device can be used for manual grinding of convex and concave surfaces.

FIG. 3 presents close-up of the console 2 with plug 4 being fixed to the lever 5 with channel 6, where the plug 4 is created by a screw and a spacing tube 17, which is placed on the screw and located in the middle of the lever 5. This tube prevents the lever and console deformation when the screw is tightened. The fixation of plugs 8 and 12 to channels 11 and 13 is similar.

This construction allows completely eliminating the flexibility of the base plate 1 and permanently setting its curve.

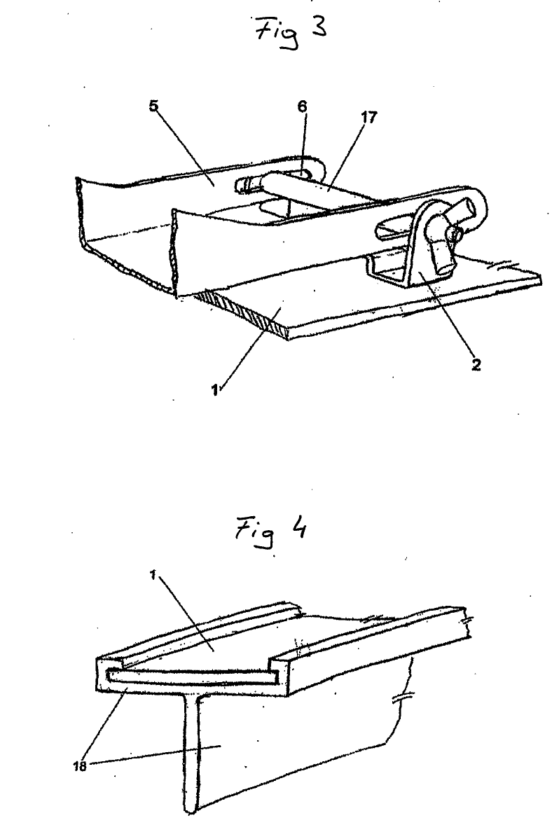

FIG. 4 presents close-up of base plate 1 being provided with plastic T-profile 18 with one wiping edge, which is perpendicular to the covered surface. This solution is advantageous namely at smoothing beams.

1-11. (canceled)

12. A spattle for wiping and smearing liquid materials, namely binders over surfaces, namely curved, characterised by comprising a flexible base plate connected to a spattle handle through mutually connected levers that evenly transfer pressure conducted on the spattle handle over the whole length of the base plate.

13. The spattle according to claim 12, characterised by the levers, base plate, and handle being mutually connected with plugs.

14. The spattle according to claim 13, characterised by the levers being provided on one end by a channel in which when the base plate is flexed, the lever plugs being closer to the base plate or consoles.

15. The spattle according to claim 14, characterised by the plugs moving in a plurality of channels, which can be fixed in the channels by a screw.

16. The spattle according to claim 12, characterised by one lever which is placed the furthest from the base plate and which is also used as the spattle's handle.

17. The spattle according to claim 12 characterised by the levers closest to the base plate being connected to the base plate with plugs placed on consoles.

18. The spattle according to claim 17, characterised by the consoles with plugs being fixed firmly to the base plate.

19. The spattle according to claim 18, characterised by the consoles forming also a stirrup for fixing an additional stiffener.

20. The spattle according to claim 19, characterised by the addition of a stiffener to the base plate.

21. The spattle according to claim 20, characterised by the base plate provided with a profile with variously situated wiping edge.

22. The spattle according to claim 21, characterised by the base plate provided with hook and loop fasteners for fixing brushing paper.
